(19) United States
(12) Patent Application Publication
(10) Pub. No.: US 2011/0147683 A1
(43) Pub. Date: Jun. 23, 2011

(54) PULLER WITH ADJUSTABLE HOOK HEAD

(76) Inventor: JUN FAN CHEN, Taichung City (TW)

(21) Appl. No.: 12/641,357

(22) Filed: Dec. 18, 2009

(51) Int. Cl. B66F 19/00

(52) U.S. Cl. 254/134

(57) ABSTRACT

A puller with an adjustable hook head comprises a hook head including an axial rotating extension rotably disposed on one end thereof, and including a plurality of toothed engaging recesses continuously arranged around an arcuate outer periphery thereof; a plate assembly including a first plate part and a second plate part, the first and the second plate parts including two connection ends disposed on one sides thereof respectively and being folded together to form a closed cavity, and the cavity including an aperture secured therein; a controlling member received in the cavity and including a driving block fixed on a top end thereof, including a retaining projection disposed on one side thereof in response to the engaging recesses of the hook head.

### BACKGROUND OF THE INVENTION

1. Field of the Invention

The present invention relates to a puller with an adjustable hook head that is capable of adjusting the hook head to a desired angle quickly.

2. Description of the Prior Art

A conventional puller with an adjustable hook head disclosed in U.S. Pat. No. 7,039,993 B1 includes an elongate handle having a manual engagement end and a seal hook member attachment end, said hook member attachment end comprising a generally flat planar member; and a seal hook member, including, (a) at least one hook element, (b) a pivot connection to the attachment end of the handle and (c) at least one connection member for engaging the handle and hook member simultaneously in one of at least two discrete rotatable positions of the hook member about the pivot connection. However, such a conventional puller is adjusted by inserting and removing a detent pull pin, and the hook head is positioned in only 4 or 5 openings, limiting rotating angle. Besides, the detent pull pin is easy to damage user's finger.

The present invention has arisen to mitigate and/or obviate the afore-described disadvantages.

### SUMMARY OF THE INVENTION

The primary object of the present invention is to provide a puller with an adjustable hook head that is capable of adjusting the hook head to a desired angle quickly.

A further object of the present invention is to provide a puller with an adjustable hook head that is capable of adjusting an angle of the hook head precisely.

Another object of the present invention is to provide a puller with an adjustable hook head that engage the retaining projection with the engaging recesses tightly to lower noise during adjusting the hook head.

To achieve the above object, a puller with an adjustable hook head provided in accordance with the present invention comprises:

a hook head including an axial rotating extension rotably disposed on one end thereof, and including a plurality of toothed engaging recesses continuously arranged around an arcuate outer periphery thereof;

a plate assembly including a first plate part and a second plate part, the first and the second plate parts including two connection ends disposed on one sides thereof respectively and being folded together to form a closed cavity, and the cavity including an aperture secured therein;

a controlling member received in the cavity and including a driving block fixed on a top end thereof, including a retaining projection disposed on one side thereof in response to the engaging recesses of the hook head.

### BRIEF DESCRIPTION OF THE DRAWINGS

FIG. 1 is a perspective view showing the assembly of a puller with an adjustable hook head in accordance with a first embodiment of the present invention;

FIG. 2 is a perspective view showing the exploded components of the puller with the adjustable hook head in accordance with the first embodiment of the present invention;

FIG. 3 is a cross sectional view showing a part of the assembly of the puller with the adjustable hook head in accordance with the first embodiment of the present invention;

FIG. 4 is a cross sectional view showing the operation of the puller with the adjustable hook head in accordance with the first embodiment of the present invention;

FIG. 5 is a plan view showing the operation of the puller with the adjustable hook head in accordance with the first embodiment of the present invention;

FIG. 6 is a perspective view showing the assembly of a puller with an adjustable hook head in accordance with a second embodiment of the present invention;

FIG. 7 is a cross sectional view showing a part of FIG. 6;

FIG. 8 is a cross sectional view showing the operation of the puller with the adjustable hook head in accordance with the second embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

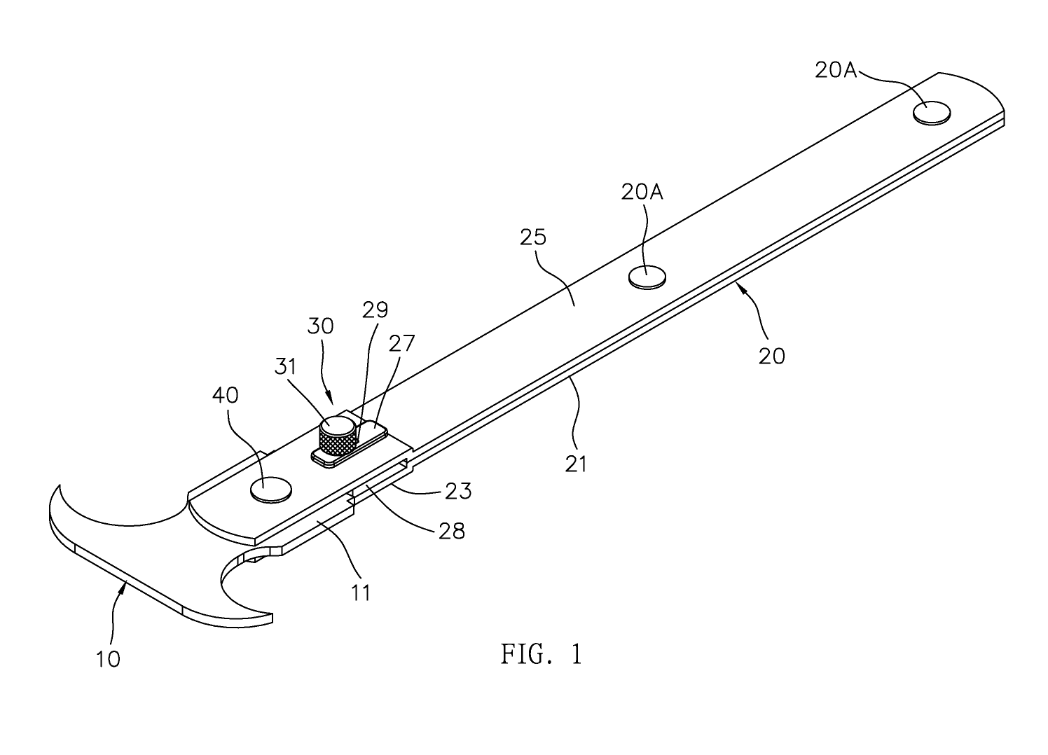

Referring to FIG. 1, a puller with an adjustable hook head in accordance with a first embodiment of the present invention comprises a hook head 10, a plate assembly 20, and a controlling member 30; the hook head 10 including an axial rotating extension 11 rotably disposed on one end thereof to be assembled with the plate assembly 20 by using a bolt 40, between the hook head 10 and the plate assembly 20 being axially mounted the controlling member 30, and the controlling member 30 including a driving block 31 fixed on a top end thereof to manually control the hook head 10.

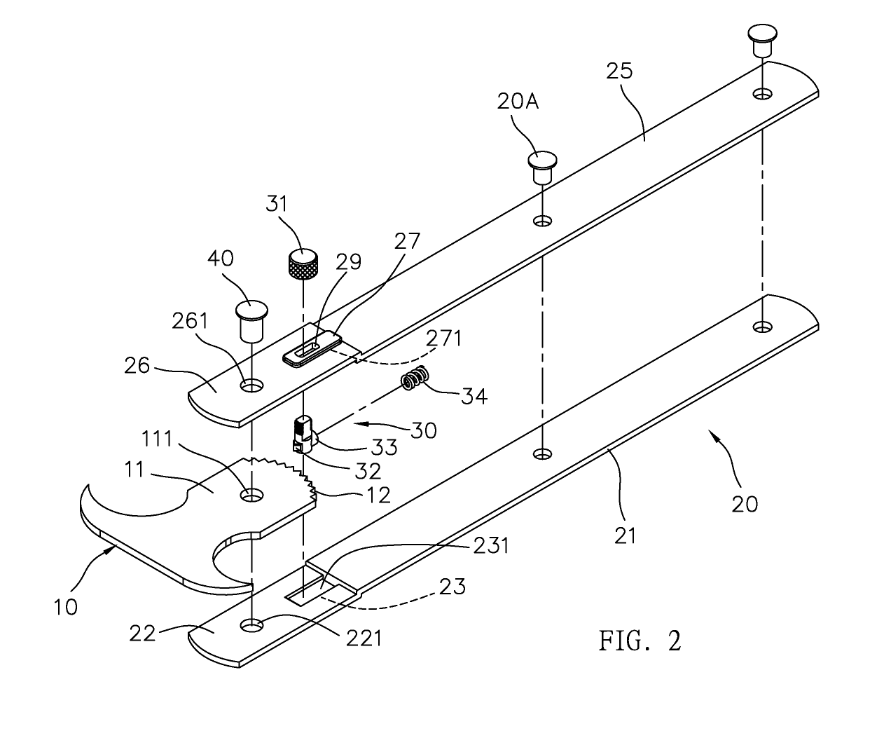

As shown in FIG. 2, the hook head 10 is formed in a tee shape, the axial rotating extension 11 of the hook head 10 includes a through hole 111 formed thereon, and the hook head 10 includes a plurality of toothed engaging recesses 12 continuously arranged around an arcuate outer periphery thereof.

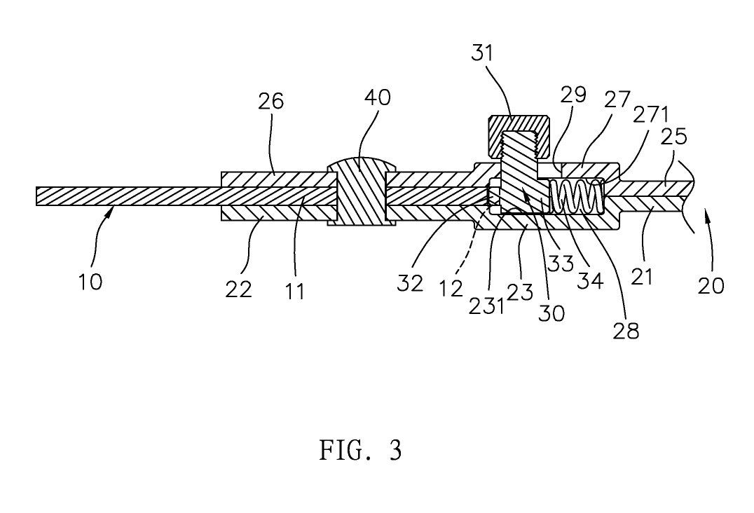

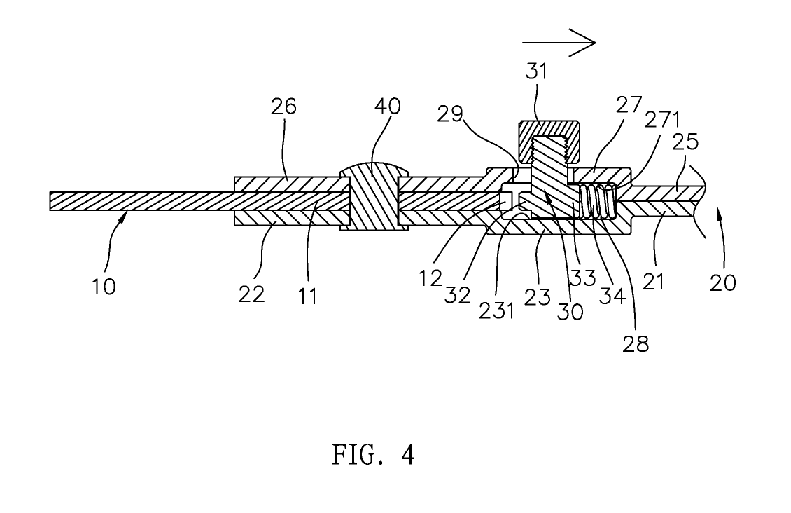

The plate assembly 20, as illustrated in FIGS. 1 and 2, is comprised of a first plate part 21 and a second plate part 25, and the first and the second plate parts 21, 25 include two connection ends 22, 26 disposed on one sides thereof respectively, and the connection ends 22, 26 include positioning bores 221, 261 arranged thereon, convex segments 23, 27 punch pressed on another sides thereof, and concave segments 231, 271 punch pressed between the convex segments 23, 27 individually, the first and the second plate parts 21, 25 are folded together to form a closed cavity 28 extending laterally as shown in FIGS. 3 and 4. The cavity 28 includes an aperture 29 secured therein, and the through hole 111 of the hook head 10 is aligned to the positioning bores 261, 221 of the connection ends 22, 26 to engage the hook head 10 by using the connection ends 22, 26, and then the bolt 40 is inserted through the positioning bores 221, 261 and the through hole 111 to generate an axial rotating point to rotate the hook head 10.

The controlling member 30, as shown in FIG. 2, also includes a retaining projection 32 and a pillar 33 secured on two sides thereof respectively; the pillar 33 matches with a resilient element 34 to be received in the cavity 28, and the driving block 31 extends out of the aperture 29 to be operated easily, and a rivet 20A and the bolt 40 are used to assemble the first and the second plate parts 21, 25 together. Besides, two ends of the resilient element 34 are pushed by inner wall of the cavity 28 and the pillar 33, therefore the retaining projection 32 is pushed laterally in the cavity 28 so as to move toward the engaging recess 12 to be retained (as illustrated in FIG. 3).

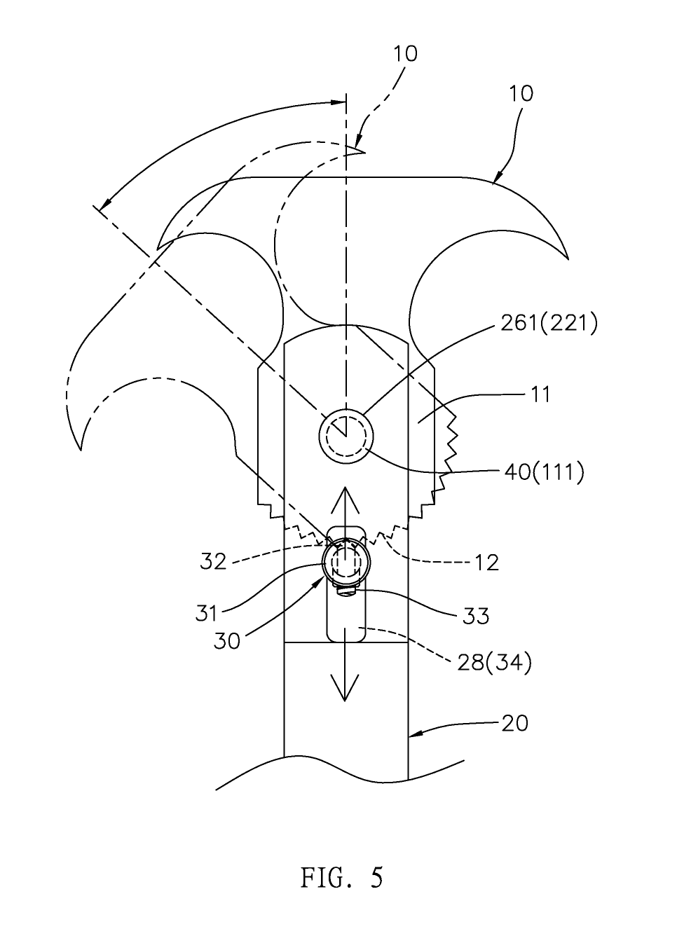

In operation, as shown in FIGS. 3-5, the user has to move the driving block 31 along the aperture 29 horizontally so as to compress the resilient element 34, such that the retaining projection 32 disengages from the engaging recesses 12 so that the hook head 10 is rotated along the bolt 40 toward a suitable angle to release the driving block 31. Thereby, the controlling member 30 is pushed by the resilient element 34 to move back along the aperture 29 and the cavity 28, and the retaining projection 32 is retained in the engaging recesses 12 again to position the hook head 10, adjusting the hook head 10.

The driving block 31 is operated to move the controlling member 30 horizontally, and then the retaining projection 32 of the controlling member 30 is engaged with or disengaged from the engaging recesses 12 of the hook head 10. However, a driving block 31A allows to be pressed vertically to engage or disengage the retaining projection 32 with or from the engaging recesses 12 as well.

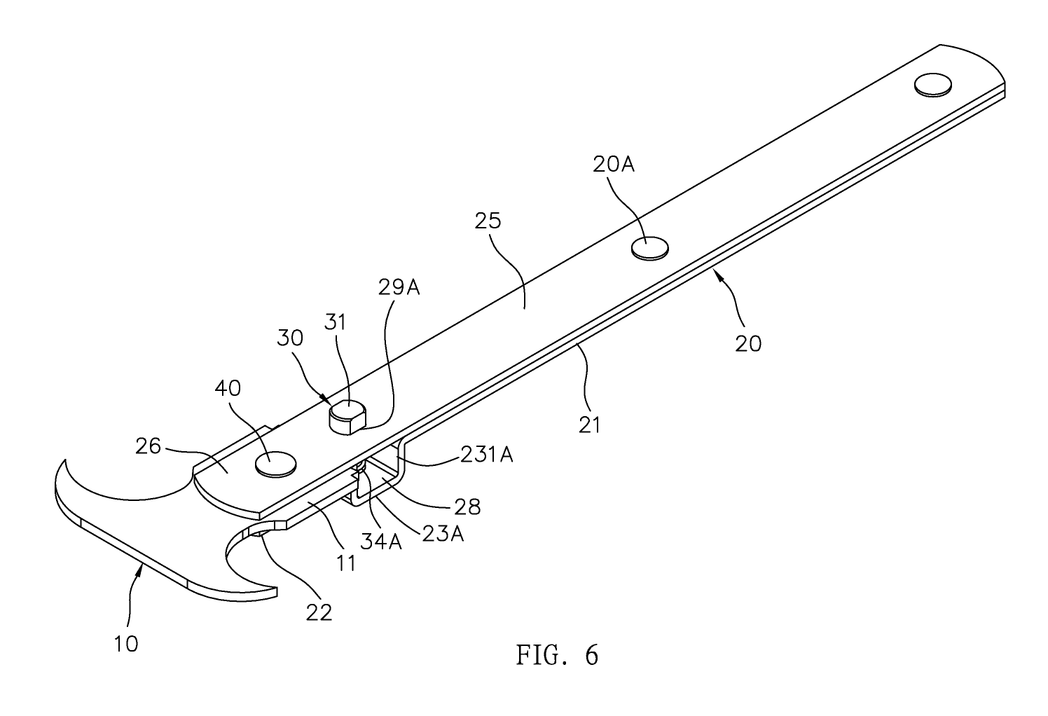

Referring to FIG. 6, a puller with an adjustable hook head in accordance with a second embodiment of the present invention comprises a plate assembly 20 having a first and a second plate parts 21, 25, wherein a connection end 26 is formed in a flat plane shape, and a connection end 22 includes a convex segment 23A and a convex segment 231A punch pressed on one side thereof, such that the first and the second plate parts 21, 25 are folded together to form a closed cavity 28A extending vertically as shown in FIGS. 6-8, and the cavity 28A includes an aperture 29A arranged thereon, such that the through hole 111 of the hook head 10 is aligned to the positioning bores 261, 221 to retain the hook head 10 by using the connection ends 22, 26, and the bolt 40 is inserted through the positioning bores 261, 221 and the through hole 111 to form an axial rotating point.

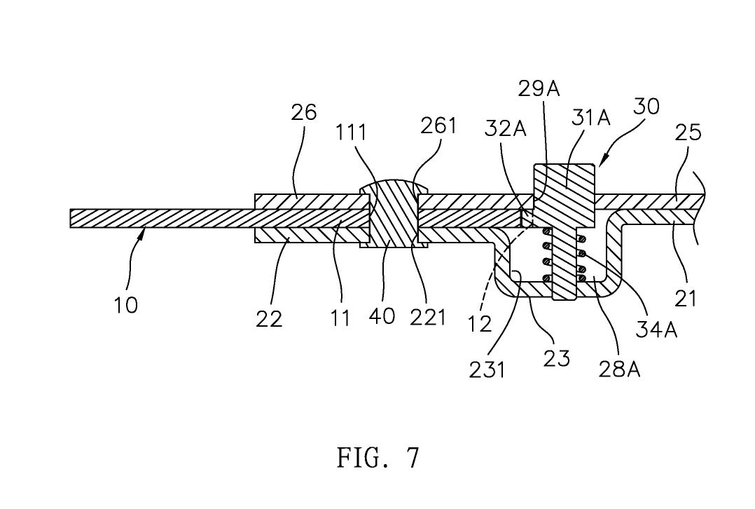

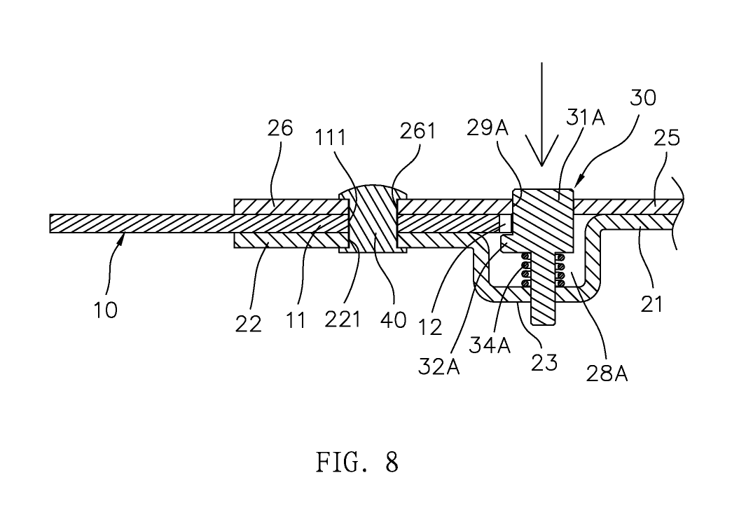

The controlling member 30 includes a driving block 31A disposed on a top end thereof and includes a retaining projection 32A mounted on one side thereof includes a resilient element 34 fitted to a bottom extension thereof. As shown in FIGS. 7 and 8, one end of the resilient element 34A abuts against a bottom end of the cavity 28A so that the controlling member 30 moves vertically along the aperture 29A.

In operation, as shown in FIGS. 7 and 8, the driving block 31A is pressed to actuate the controlling member 30 to move downward to compress the resilient element 34A so that the retaining projection 32A longitudinally disengages from the engaging recesses 12 such that the hook head 10 rotates to a suitable angle along the bolt 40 to release the controlling member 30, and then the controlling member 30 is pushed by the resilient element 34A to move upward along the aperture 29A, hence the retaining projection 32A retains in the engaging recesses 12 again to position the hook head 10.

While we have shown and described various embodiments in accordance with the present invention, it is clear to those skilled in the art that further embodiments may be made without departing from the scope of the present invention.

What is claimed is:

1. A puller with an adjustable hook head comprising:
a hook head including an axial rotating extension rotably disposed on one end thereof, and including a plurality of toothed engaging recesses continuously arranged around an arcuate outer periphery thereof;
a plate assembly including a first plate part and a second plate part, the first and the second plate parts including two connection ends disposed on one sides thereof respectively and being folded together to form a closed cavity, and the cavity including an aperture secured therein;
a controlling member received in the cavity and including a driving block fixed on a top end thereof, including a retaining projection disposed on one side thereof in response to the engaging recesses of the hook head.

2. The puller with the adjustable hook head as claimed in claim 1, wherein the hook head is formed in a tee shape, and the axial rotating extension of the hook head includes a through hole formed thereon; the connection ends include positioning bores arranged thereon, and the cavity extends laterally, the connection ends include convex segments punch pressed on another sides thereof, and concave segments punch pressed between the convex segments individually, two ends of the resilient element are pushed by an inner wall of the cavity and the pillar so that the driving block laterally moves along the aperture to actuate the controlling member to move, and the through hole of the hook head is aligned to the positioning bores to insert a bolt.

3. The puller with the adjustable hook head as claimed in claim 1, wherein the hook head is formed in a tee shape, and one of the connection ends is formed in a flat plane shape, and another connection end includes a convex segment and a convex segment punch pressed on one side thereof, the first and the second plate parts are folded together to form another closed cavity extending vertically, and the cavity includes an aperture arranged thereon, the through hole of the hook head is aligned to the positioning bores to retain the hook head by using the connection ends, and the bolt is inserted through the positioning bores and the through hole to form an axial rotating point, the controlling member includes another driving block disposed on a top end thereof and includes another retaining projection mounted on one side thereof, includes another resilient element fitted to a bottom extension thereof, one end of the resilient element abuts against a bottom end of the cavity so that the controlling member moves vertically along the aperture.
